(19) United States
(12) Patent Application Publication
(10) Pub. No.: US 2006/0004947 A1
(43) Pub. Date: Jan. 5, 2006

(54) File updating method

(76) Inventor: Wei-Sheng Yin, Taitung City (TW)

Correspondence Address: RABIN & Berdo, PC, 1101 14TH STREET, NW, SUITE 500, WASHINGTON, DC, 20005, US

(21) Appl. No.: 11/154,724

(22) Filed: Jun. 17, 2005

(30) Foreign Application Priority Data
Jun. 18, 2004 (TW) 93117811

(51) Int. Cl. G06F 12/00

(52) U.S. Cl. 711/100

(57) ABSTRACT

A file updating method applied in an electronic system for updating data is provided. In step a, an available second physical sector is obtained and mapped to an update logical sector in the data region. In step b, the update data corresponding to the update logical sector is written into the second physical sector. In step c, the steps a and b are repeated until the update data corresponding to all of the update logical sectors in the data region has been written into the mapped/corresponding second physical sectors thereof. In step d, the status of at leas one of the second physical sectors mapped to the update logical sectors is set to be “BEINGVALIDATED”.

This application claims the benefit of Taiwan application Serial No. 9311781 1, filed Jun. 18, 2004, the subject matter of which is incorporated herein by reference.

### BACKGROUND OF THE INVENTION

1. Field of the Invention

The invention relates in general to a file updating method, and more particularly to a file updating method with power-off protection for file updating.

2. Description of the Related Art

Referring to FIG. 1A, a structural diagram of a conventional sector-based electronic system is shown. In FIG. 1A, electronic system 10 comprises an application program 11, a file allocation table (FAT) subsystem 12, a disc driver 13 and a disc storage device 14. If the electronic system 10 is a mobile phone system, the disc storage device 14 is normally a flash memory. The characteristics of the flash memory is that the electronic system 10 must erase data first before further writing any data into the flash memory, wherein the size of an erase unit can be, e.g. 8 K bytes or 64 K bytes. The file allocation table subsystem 12 divides the storage space into a plurality of logical sectors, wherein each logical sector is a minimum data storage unit. The size of each logical sector can be, e.g. 512 bytes. If the size of the to-be-stored data is less than one logical sector, a logical sector storage space would still be located by the electronic system 10 for storing that data.

According to the size of the logical sector defined by upper-level FAT subsystem 12, the disc driver 13 would divide the disc storage device 14 into a plurality of physical sectors of equal size which are used as physical storage units. The size of each physical sector can be, e.g. 512 bytes, wherein each physical sector has a piece of corresponding sector information on the flash memory. Each piece of sector information comprises two columns: one is a logical sector ID to which the physical sector is mapped in the FAT subsystem 12, and another one is a sector status of the physical sector.

Moreover, the application program 11 uses the application program interface provided by the FAT subsystem 12 to access the data stored in the disc storage device 14 for file processing. For example, the electronic system 10 can use the application program 11 to create, modify, read and close a file.

Generally speaking, the FAT subsystem 12 defines a plurality of logical sectors, and the disc driver 13 writes the data to which the logical sectors correspond into a plurality of physical sectors of the disc storage device 14. Each logical sector corresponds to a physical sector, and the electronic system 10 further comprises a mapping table (not shown here) for recording the mapping relationship between logical sectors and physical sectors. When updating a file, the conventional application program 11 can either have new data for updating the file directly written into the physical sector in which the old data is stored or have the new data written into a blank physical sector first. The former practice is called as “direct-mapping updating method”, and the latter is called as “indirect-mapping updating method”.

In the direct-mapping updating method as shown in FIG. 1B, it is supposed that data of a file corresponds to logical sectors 12(1)˜12(N), and the disc driver 13 stores the data corresponding to the logical sector 12(1)˜12(N) in physical sectors 14(1)˜14(N) in a one-to-one mapping way, shown as the solid arrows of FIG. 1B. Meanwhile, the logical sectors 12(1)˜12(N) are mapped to the physical sectors 14(1)˜14(N), wherein the sector information of each physical sector keeps the information of a logical sector ID to which the physical sector is mapped in the FAT subsystem 12, and sector status of the physical sector. The logical sector IDs of the physical sectors 14(1)˜14(N) respectively record the IDs of logical sectors 12(1)˜12(N) to which the physical sectors 14(1)˜14(N) are separately mapped. Since all the physical sectors 14(1)˜14(N) have data stored therein, the status of all of the physical sectors 14(1)˜14(N) are “VALID”.

During file updating, if the new data for updating the file corresponds to the logical sectors 12(1)˜12(3), the disc driver 13 would erase the old data stored in the physical sector 14(1) first, and then write the new data corresponding to the logical sector 12(1) into the physical sector 14 (1), shown as the dotted arrow in FIG. 1B. Next, the disc driver 13 would erase the old data stored in the physical sector 14(2) first, and then write the new data corresponding to the logical sector 12(2) into the physical sector 14 (2), shown as the dotted arrow in FIG. 1B. After that, the disc driver 13 would erase the old data stored in the physical sector 14(3) first, and then write the new data corresponding to the logical sector 12(3) into the physical sector 14(3), shown as the dotted arrow in FIG. 1B. That is to say, the disc driver 13 would directly and sequentially erase old data, and then write new data into the physical sector to which the logical sector is mapped, to which the new data is corresponding to.

The disc driver 13 must erase old data stored in the physical sector before writing new data into. If the power is abruptly cut off when the disc driver 13 is erasing the old data stored in the physical sector 14(2), only the data stored in the physical sector 14(1) would have been updated and the data stored in the physical sector 14(3) would still be the old data. Since the old data stored in the physical sector 14(2) have been erased, moreover, the new data corresponding to the logical sector 12(2) is stored in a buffer memory (not shown here), the interruption of the system power supply would cause the new data corresponding to the logical sector 12(2) lost. In other words, if the system is abruptly power-off during file updating by applying the direct-mapping updating method, the old data and the new data might be mixed up or even be lost and damaged.

In the indirect-mapping updating method shown in FIG. 1C, it is supposed that data of a file corresponds to the logical sector 12(1)˜12(N) and the disc driver 13 has the data corresponding to the logical sector 12(1)˜12(N) stored in the physical sectors 14(1)˜14(N) in a one-to-one mapping way, shown as solid arrows in FIG. 1C. Meanwhile, a mapping table 15 records the mapping relation between logical sectors and physical sectors. For example, the mapping table 15 records that the logical sector 12(1)˜12 (N) are mapped to the physical sectors 14(1)˜14(N). Moreover, the status of all of the physical sectors 14(1)˜14(N) are “VALID”.

During the period of using the application program 11 to update the file, if the new data for updating the file corresponds to the logical sector 12(1)˜12(3), the disc driver 13 will first obtain a physical sector whose sector status is “AVAILABLE” from the disc storage device 14, for example, a physical sector 14(N+1). Next, the disc driver 13 writes the new data corresponding to the logical sector 12(1) into the physical sector 14(N+1), and the mapping table 15 records the mapping relationship between the logical sector 12(1) and the physical sector 14(N+1). However, the physical sector 14(1) would still correspond to the logical sector 12(1) and the old data stored in the physical sector 14(1) would not be deleted. In other words, the physical sector 14(1) in which the old data is stored and the physical sector 14(N+1) in which the new data is stored correspond to the logical sector 12(1) at the same time.

After that, the disc driver 13 deletes the old data stored in the physical sector 14(1) originally corresponding to the logical sector 12(1). That the mapping table 15 deletes the mapping relationship between the logical sector 12(1) and the physical sector 14(1), which means that the physical sector 14(1) becomes an available physical sector whose sector status has been changed to “AVAILABLE”. Meanwhile, the logical sectors 12 (1) only correspond to the physical sector 14(N+1) having new data stored therein.

Next, the disc driver 13 obtains a physical sector whose sector status is “AVAILABLE” from the disc storage device 14, for example, a physical sector 14(N+2). The disc driver 13 writes the new data corresponding to the logical sectors 12(2) into the physical sector 14(N+2), and the mapping table 15 records the mapping relationship between the logical sector 12(2) and the physical sector 14(N+2). However, the physical sector 14(2) would still correspond to the logical sector 12(2) and the old data stored therein would not be deleted. In other words, the physical sector 14(2) in which the old data is stored and the physical sector 14(N+2) in which the new data is stored correspond to the logical sector 12(2) at the same time.

After that, the disc driver 13 deletes the old data stored in the physical sector 14(2) originally corresponding to the logical sectors 12(2). Then, the mapping table 15 deletes the mapping relationship between the logical sectors 12(2) and the physical sector 14(2), which means that the physical sector 14(2) becomes an available physical sector whose sector status has been changed to “AVAILABLE”. Meanwhile, the logical sector 12 (2) only corresponds to the physical sector 14(N+2) having new data stored therein.

Next, the disc driver 13 obtains a physical sector whose sector status is “AVAILABLE” from the disc storage device 14, for example, a physical sector 14(N+3). The disc driver 13 writes the new data corresponding to the logical sector 12(3) into the physical sector 14(N+3), and the mapping table 15 records the mapping relationship between the logical sector 12(3) and the physical sector 14(N+3). However, the physical sector 14(3) would still correspond to the logical sector 12(3) and the old data stored therein would not be deleted. In other words, the physical sector 14(3) in which the old data is stored and the physical sector 14(N+3) in which the new data is stored correspond to the logical sector 12(3) at the same time.

After that, the disc driver 13 deletes the old data stored in the physical sector 14(3) originally corresponding to the logical sector 12(3). Then, the mapping table 15 deletes the mapping relationship between the logical sector 12(3) and the physical sector 14(3), which means that the physical sector 14(3) becomes an available physical sector whose sector status has been changed to “AVAILABLE”. Meanwhile, the logical sector 12 (3) only corresponds to the physical sector 14(N+3) having new data stored therein.

That is to say, the disc driver 13 writes the new data into an available physical sector first, and then deletes the old data afterwards. Therefore, if power supply is abruptly cut off when the new data is being written into the physical sector 14(N+3), complete old data would still be stored in the physical sector 14(3). However, old data would be mixed up with new data, i.e., the physical sectors corresponding to the logical sectors 12(1) and 12(2) already have new data stored therein while the physical sector corresponding to the logical sector 12(3) still keeps the old data.

In the first file updating method of FIG. 1B, due to the characteristics of the flash memory, the physical sector must have old data erased first before have new data written into, that is to say, the new data can not be directly written into the physical sector corresponding to the logical sector. Namely, the new data cannot be directly written into the physical sector corresponding to the logical sector. If power supply is abruptly cut off when the new data is being written into the disc storage device 14 by the disc driver 13, only part of the new data would have been written into the disc storage device 14, causing old data to be lost and new data to be incomplete. In the second file updating method of FIG. 1C, according to the conventional method, having the new data written into the available physical sector first before having the original old data of the physical sector deleted, it is possible that only part of the data would have been updated and old data would be mixed up with new data if power supply is abruptly cut off when the new data is being written into the disc storage device 14 by the disc driver 13.

### SUMMARY OF THE INVENTION

Therefore, the object of the invention is to provide a file updating method, which first determines whether the physical sector(s) is/are at the status of “BEINGVALIDATED” or not, and then determines the operations for recovering the file after the abrupt power-off. The present invention not only avoids the mixture of old data and new data, but also achieves power-off protection for file updating.

According to an object of the invention, a file updating method applied in an electronic system for updating a file is provided. The electronic system comprises at least one logical sector and at least one physical sector, wherein each logical sector corresponds to a physical sector in which the data corresponding to the logical sector is stored. The file is stored in the electronic system and comprises at least one file logical sector, wherein each file logical sector corresponds to a first physical sector in which the data corresponding to the file logical sector is stored. The file comprises a to-be-updated data region, wherein the data region comprises at least one update logical sector which can correspond to a first physical sector. The method begins at step a: an available second physical sector is obtained and is mapped to an update logical sector in the data region. Next, the method proceeds to step b: the update data of the update logical sector is written into the second physical sector. After that, the method proceeds to step c: the above steps a and b are repeated until the update data of all of the update logical sectors in the data region has been written into the corresponding second physical sectors thereof. Lastly, the method proceeds to step d: the status of at least one of the second physical sectors mapped to the update logical sectors is set to be “BEINGVALIDATED”.

According to another object of the invention, an electronic system comprising at least one logical sector, at least one physical sector, at least one file, an available physical sector obtain module, a write module, a first determine module and a first status-setting module is provided. Each logical sector corresponds to a physical sector in which the data corresponding to the logical sector is stored. Each file comprises at least a file logical sector, wherein each file logical sector corresponds to a first physical sector in which the data corresponding to the file logical sector is stored. The file comprises a to-be-updated data region, wherein the data region comprises at least an update logical sector which corresponds to a first physical sector. The available physical sector obtain module is used for obtaining and mapping an available second physical sector to an update logical sector in the data region. The write module is used for writing the update data of the update logical sector into the second physical sector. The first determine module is used for determining whether the update data of all of the update logical sectors in the data region has been written into the corresponding second physical sectors thereof. The first status-setting module is used for setting the status of at least one of the second physical sectors mapped to the update logical sectors to be “BEINGVALIDATED”.

It is still another object of the invention to provide a method for recovering data update applied in an electronic system comprising at least a logical sector, at least a physical sector and at least a second physical sector, wherein each logical sector corresponds to a physical sector in which the data corresponding to the logical sector is stored. The file is stored in the electronic system and comprises at least a file logical sector, wherein each file logical sector corresponds to a first physical sector in which the data corresponding to the file logical sector is stored. The file comprises a to-be-updated data region, wherein the data region comprises at least an update logical sector. Each of the update logical sectors corresponds a first physical sector, while each of the second physical sectors corresponds to an update logical sector in the data region. The method, first of all, determines whether any of the second physical sectors mapped to the update logical sectors is at “BEINGVALIDATED” status: if so, an update-completing procedure is performed, otherwise, an updated-data deleting procedure is performed.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A(Prior Art) is a structural diagram of a conventional sector-based electronic system;

FIG. 1B(Prior Art) shows a conventional direct-mapping updating method;

FIG. 1C(Prior Art) shows a conventional indirect-mapping updating method;

FIG. 2 is a block diagram of an electronic system according to a preferred embodiment of the invention;

FIG. 3 is a flowchart of a file updating method according to a preferred embodiment of the invention;

FIG. 4 is a flowchart of a method for recovering data update according to a preferred embodiment of the invention;

FIG. 5 is a schematic diagram of an updating-completing procedure of FIG. 4; and

FIG. 6 is a schematic diagram of an update-data deleting procedure of FIG. 4.

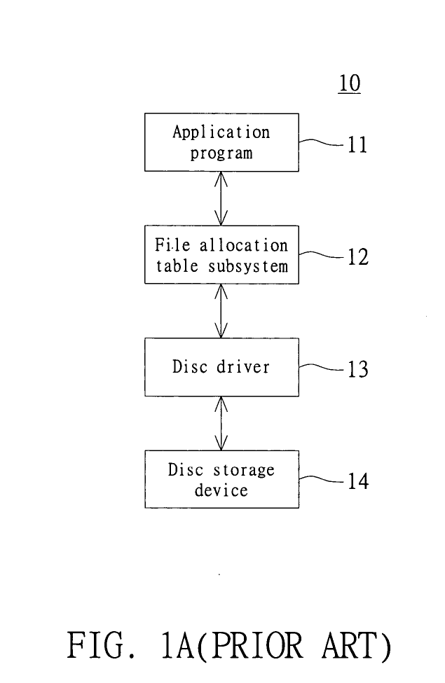

### DETAILED DESCRIPTION OF THE INVENTION

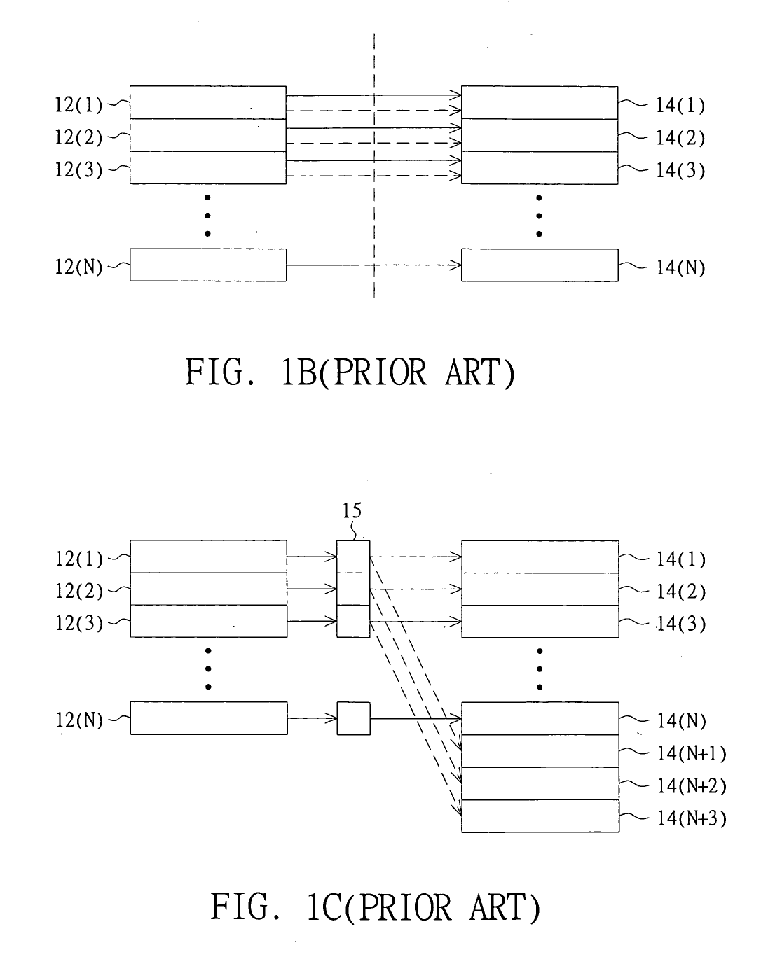

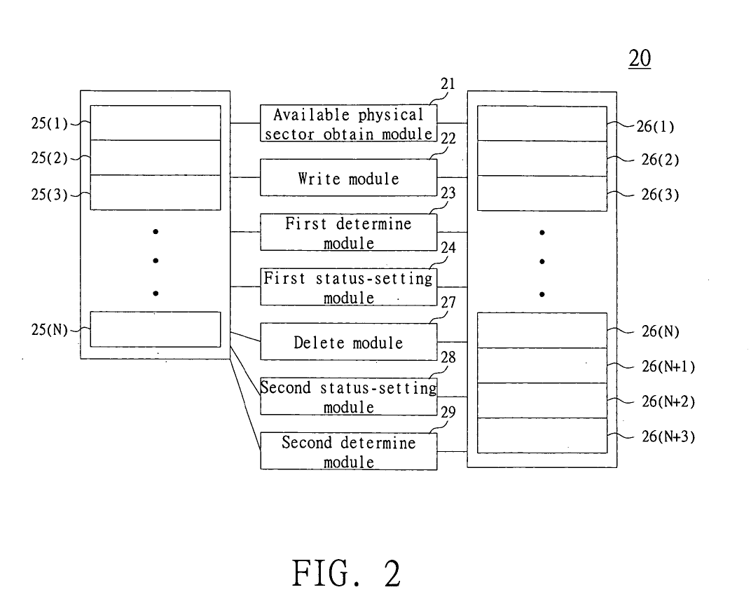

Referring to FIGS. 2˜3, wherein FIG. 2 is a block diagram of an electronic system according to a preferred embodiment of the invention, while FIG. 3 is a flowchart of a file updating method according to a preferred embodiment of the invention. As shown in FIG. 2, electronic system 20 comprises an available physical sector obtain module 21, a write module 22, a first determine module 23, a first status-setting module 24, a delete module 27, a second status-setting module 28, a second determine module 29, at least a file, at least a logical sector, and at least a physical sector. In the electronic system 20, each logical sector corresponds to a physical sector in which the data corresponding to the logical sector is stored. Each file comprises at least a file logical sector, each of which corresponds to a first physical sector, wherein the data corresponding to the file logical sectors is stored in the first physical sector mapped to all of the file logical sectors.

As shown in FIG. 2, it is supposed that the data of a file corresponds to logical sectors 25(1)˜25(N), wherein the logical sectors 25(1)˜25(N) correspond to physical sector 26(1)˜26(N). Before the data of the file is updated, the logical sectors 25(1)˜25(N) are file logical sectors as defined above, and the physical sector 26(1)˜26(N) are first physical sectors having data stored therein. When the data of the file is to be updated, the file comprises a to-be-updated data region, wherein the data region comprises at least an update logical sector, each of which corresponds to a first physical sector. Suppose the to-be-updated data region comprises the logical sectors 25(1)˜25(3), and then the logical sectors 25(1)˜25(3) are the update logical sectors as defined above, wherein the logical sectors 25(1)˜25(3) correspond to the physical sectors 26(1)˜26(3).

Refer to FIG. 3, the method begins at step 31: when the data of the file is to be updated, an available second physical sector is obtained and mapped to an update logical sector in the data region by the available physical sector obtain module 21. The status of the available second physical sector is “AVAIABLE” or “DELETED”, so the available physical sector obtain module 21 uses the physical sector whose status is “AVAIABLE” or “DELETED” as an available second physical sector. After that, the method proceeds to step 32: the update data corresponding to an update logical sector is written into an obtained second physical sector by the write module 22. Next, the method proceeds to step 33: the above steps 31 and 32 are repeated until the first determine module 23 determines that the update data corresponding to all of the update logical sectors in the data region has been written into the corresponding second physical sectors thereof.

Steps 31˜33 are further exemplified below, where it is assumed that the update logical sectors are the logical sectors 25(1)˜25(3). First, an available physical sector 26(N+1) is obtained and mapped to the logical sector 25(1), to which the update data is corresponding, by the available physical sector obtain module 21(step 31). Then, the update data corresponding to the logical sector 25(1) is written into the available physical sector 26(N+1) by the write module 22 (step 32). Next, an available physical sector 26(N+2) is obtained and mapped to the logical sector 25(2), to which the update data is corresponding, by the available physical sector obtain module 21 (step 31). Then, the update data corresponding to the logical sector 25(2) is written into the available physical sector 26(N+2) by the write module 22 (step 32). After that, an available physical sector 26 (N+3) is obtained and mapped to the logical sector 25(3), to which the update data is corresponding, by the available physical sector obtain module 21 (step 31). Then, the update data corresponding to the logical sector 25(3) is written into the available physical sector 26(N+3) by the write module 22 (step 32).

To assure that the update data corresponding to all of the update logical sectors has been written into the second physical sectors, to which the update logical sectors are mapped, the electronic system 20 uses the first determine module 23 to determine whether the update data corresponding to all of the update logical sectors in the data region has been written into the mapped second physical sectors (step 33). Once the data of a second physical sector is updated, the status of the sector information of that second physical sector becomes “WRITTEN”, and the sector information of that second physical sector has the ID of the update logical sector, which is mapped to that second physical sector. Then, the first determine module 23 makes judgment according to the sector information of the second physical sector. When the first determine module 23 determines that a plurality of second physical sectors are at the status of “WRITTEN” and are mapped to all of the update logical sectors, it is determined that the update data of the file has been written into the second physical sectors.

After the first determine module 23 has determined that the update data corresponding to all of the update logical sectors in the data region has been written into the second physical sectors, to which the update logical sectors are mapped, then method proceeds to step 34: the statuses of all of the second physical sectors, to which the update logical sectors are mapped, are set to be “BEINGVALIDATED” by the first status-setting module 24. This means that the data of the file has been updated in the physical sectors. In other embodiments, the first status-setting module 24 sets the status of at least one of second physical sectors, to which all of the update logical sectors are mapped, to be “BEINGVALIDATED”.

The data region comprises the logical sectors 25(1)˜25(3), so the first determine module 23 determines whether the update data corresponding to the logical sectors 25(1)˜25(3) in the data region has been written into the physical sectors 26(N+1)˜26(N+3), to which the logical sectors 25(1)˜25(3) are mapped. The first status-setting module 24 sets the statuses of the physical sectors 26(N+1)˜26(N+3), which is mapped to the logical sectors 25(1)˜25(3), to be “BEINGVALIDATED” after the first determine module 23 has determined that the update data corresponding to the logical sectors 25(1)˜25(3) in the data region has been written into the mapped physical sectors 26(N+1)˜26(N+3) thereof, i.e., when the first determine module 23 determines that the statuses of the physical sectors 26(N+1)˜26(N+3) are set as “WRITTEN” and the sector information of the physical sectors 26(N+1)˜26(N+3) has the IDs of the mapped logical sectors 25(1)˜25(3). Alternatively, the first status-setting module 24 sets the status of at least one of the physical sectors 26(N+1)˜26(N+3), to which the logical sectors 25(1)˜25(3) are mapped, to be “BEINGVALIDATED”. To the contrary, when the first determine module 23 determines that the update data corresponding to the logical sectors 25(1)˜25(3) in the data region has not been completely written into the mapped physical sectors 26(N+1)˜26(N+3) thereof, it is determined that the data of the file has not been completely updated. Therefore, the first status-setting module 24 would not set the status of any of the physical sectors 26(N+1)˜26(N+3) mapped to the logical sectors 25(1)˜25(3) to be “BEINGVALIDATED”.

After the status of at least one of the second physical sectors mapped to all of the update logical sectors is set to be “BEINGVALIDATED”, the method proceeds to step 35: the delete module 27 is used to delete the data in the first physical sectors mapped to the update logical sectors in the data region, and the statuses of the first physical sectors are set to be “DELETED” or “AVAILABLE”. Since the physical sectors 26(1)˜26(3) are mapped to the logical sectors 25(1)˜25(3), the delete module 27 deletes the data in the physical-sectors 26(1)˜26(3) mapped to the logical sectors 25(1)˜25(3) in the data region, and the statuses of all of the physical sectors 26(1)˜26(3) are set to be “DELETED” or “AVAILABLE”. After the data in the physical sectors 26(1)˜26(3) is deleted, the method proceeds to step 36: the second status-setting module 28 is used to set the statuses of the second physical sectors mapped to all of the update logical sectors to be “VALID”. That is to say, the second status-setting module 28 sets the statuses of the physical sectors 26(N+1)˜26(N+3) mapped to the logical sectors 25(1)˜25(3) to be “VALID”.

It is noteworthy that the available physical sector obtained in step 31 of FIG. 3 can be any available physical sector and that the physical sectors 26(N+1)˜26(N+3) are only for exemplification.

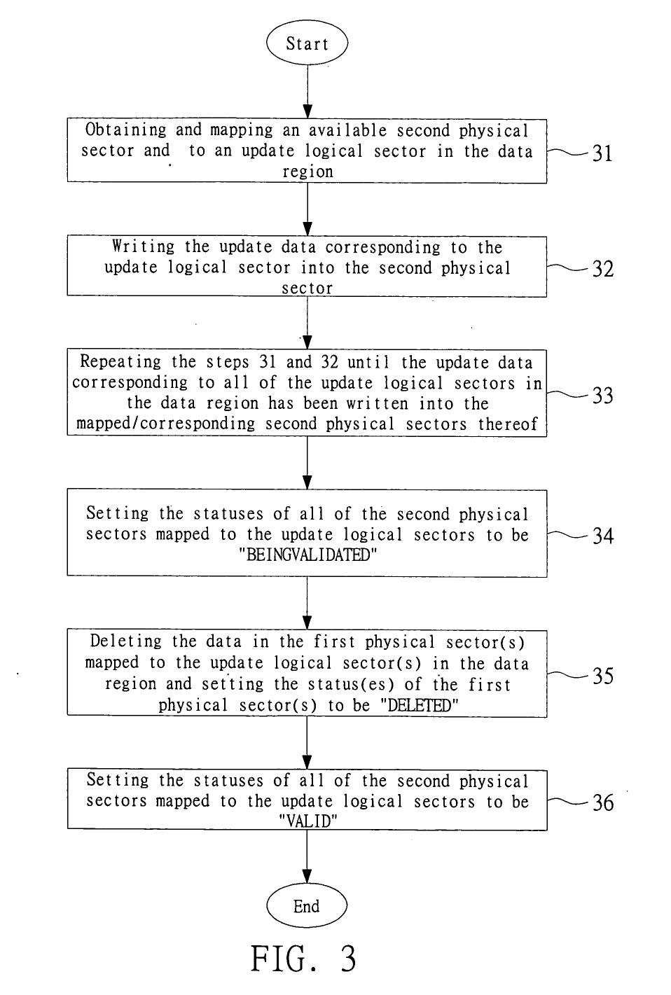

Referring to FIG. 4, a flowchart of a method for recovering data update according to a preferred embodiment of the invention is shown. The method for recovering data update of the present embodiment is applied in the electronic system 20 of FIG. 2. The electronic system further comprises a second determine module 29 and at least a second physical sector, wherein each second physical sector is mapped/corresponds to an update logical sector in the data region.

If the power is abruptly cut off during the data updating, then the electronic system can use the method for recovering the data update to recover the data update after power supply is resumed.

As shown in FIG. 4, the method begins at step 41: when the power supply is resumed after the power-off and the electronic system 20 works as usual, the second determine module 29 determines whether any of the second physical sectors mapped to the update logical sectors is at “BEINGVALIDATED” status. Meanwhile, the second determine module 29 examines whether all of the physical sectors 26(1)˜26(N+3) are at “BEINGVALIDATED” status. When the second determine module 29 determines at least one of the physical sectors 26(N+1)˜26(N+3) mapped to the logical sectors 25(1)˜25(3) is at “BEINGVALIDATED” status, the method proceeds to step 42: an update-completing procedure is performed. When the second determine module 29 determines none of the physical sectors 26(N+1)˜26(N+3) mapped to the logical sectors 25(1)˜25(3) is at “BEINGVALIDATED” status, it is determined that the data of the file has not been completely updated before the abrupt power-off, and the method then proceeds to step 43: an updated-data-deleting procedure is performed.

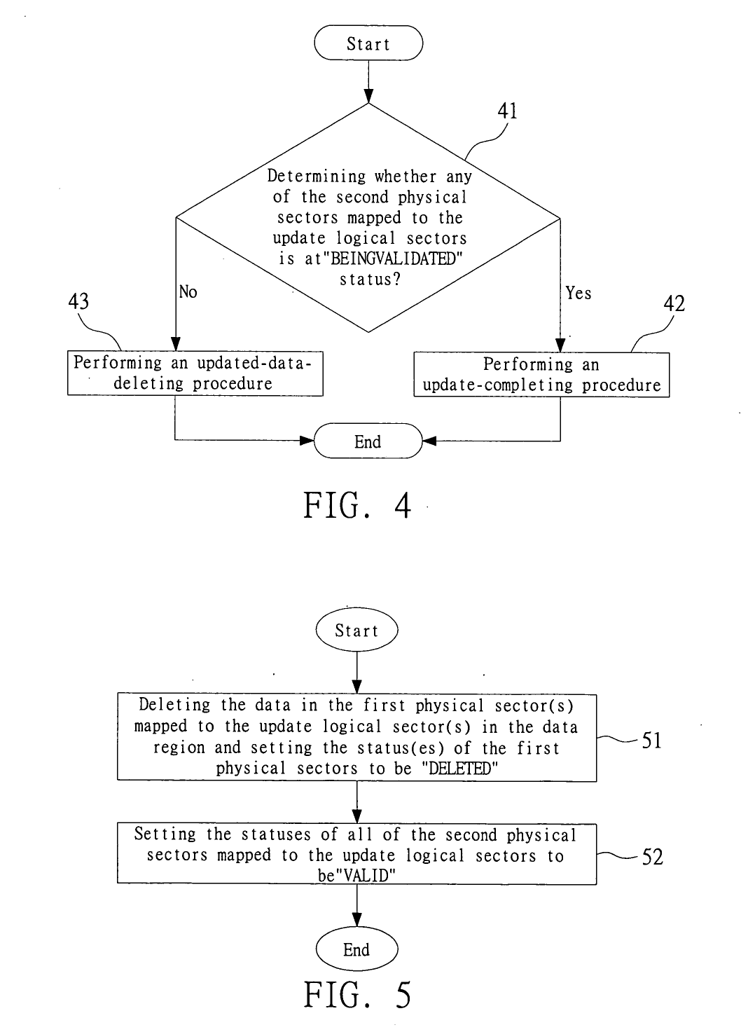

Referring to FIG. 5, a schematic diagram of the update-completing procedure of FIG. 4 is shown. When the second determine module 29 determines that at least a physical sector of the physical sectors 26(N+1)˜26(N+3) mapped to the logical sectors 25(1)˜25(3) is at “BEINGVALIDATED” status, it is determined that the data updating method of FIG. 3 has completed step 34, and thereby the electronic system only needs to perform the step 35 and step 36 to complete the data updating.

As shown in FIG. 5, the method begins at step 51: the delete module 27 is used to delete the data in the first physical sectors mapped to the update logical sectors in the data region, and then the statuses of the first physical sectors are set to be “DELETED” or “AVAILABLE”. Since the physical sectors 26(1)˜26(3) are mapped to the logical sectors 25(1)˜25(3), the delete module 27 deletes the data in the physical sectors 26(1)˜26(3) mapped to the logical sectors 25(1)˜25(3) in the data region, and all of the statuses of the physical sectors 26(1)˜26(3) are set to be “DELETED” or “AVAILABLE”. After the data in the physical sectors 26(1)˜26(3) is deleted the method proceeds to step 52: the second status-setting module 28 is used to set the statuses of the second physical sectors mapped to all of the update logical sectors to be “VALID”. That is to say, the second status-setting module 28 sets the statuses of the physical sectors 26(N+1)˜26(N+3) mapped to the logical sectors 25(1)˜25(3) to be “VALID”.

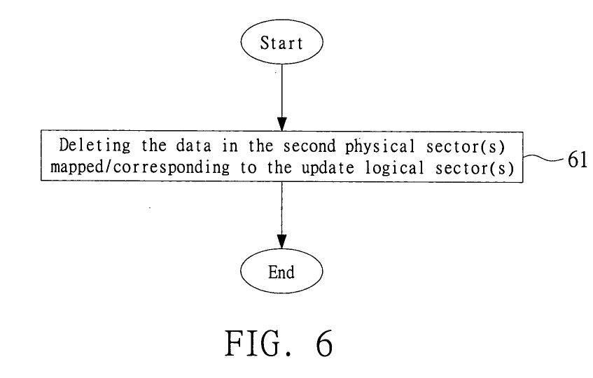

Referring to FIG. 6, a schematic diagram of the update-data-deleting procedure of FIG. 4 is shown. When the second determine module 29 determines that none of the physical sectors 26(N+1)˜26(N+3) mapped to the logical sectors 25(1)˜25(3) is at “BEINGVALIDATED” status, it is determined that the data updating method of FIG. 3 has not yet written the update data corresponding to all of the update logical sectors into the mapped second physical sector thereof. The update data is temporarily stored in a buffer memory before being written into the second physical sectors, so the abrupt system power-off would cause the update data stored in the buffer memory to disappear. However, the electronic system still keeps the complete old data, and after power supply is resumed, the electronic system would perform an updated-data-deleting procedure to delete the part of update data which has been stored in the second physical sector(s) mapped to the update logical sector(s), i.e., the incomplete update data would be deleted.

As shown in FIG. 6, the updated-data-deleting procedure has only one step, i.e., step 61: the delete module 27 deletes the data in the second physical sector(s) mapped to the update logical sector(s). Suppose only the update data corresponding to the logical sectors 25(1)˜25(2) is stored in the physical sectors 26(N+1)˜26(N+2) mapped to the logical sectors 25(1)˜25(2), but the physical sector 26(N+3) mapped to the logical sector 25(3) does not have any update data corresponding to the logical sector 25(3) stored therein. The delete module 27 would delete the data in the physical sectors 26(N+1)˜26(N+2) and the second status-setting module 28 would set the statuses of the physical sectors 26(N+1)˜26(N+2) to be “DELETED” or “AVAILABLE”.

To summarize, when the electronic system of the invention recovers the data update after the abrupt power-off, it only needs to determine whether any of the second physical sectors mapped to all of the update logical sectors is at “BEINGVALIDATED” status. If none of the second physical sectors mapped to all of the update logical sectors is at “BEINGVALIDATED” status, it means that the data updating has not been completed before the abrupt power-off, and the data in the second physical sectors must be deleted. If the status of at least one of the second physical sectors mapped to all of the update logical sectors is “BEINGVALIDATED”, it means that the application program has already completed the data updating before the abrupt power-off. Therefore, the electronic system 20 only needs to continuously perform the to-be-completed operations before the abrupt power-off as shown in FIG. 5. Therefore, the recovery process after the power-off assures the accuracy of data and avoids the mixture of new data and old data.

However, anyone who is skilled in the related technology will understand that the technology of the present embodiment is not limited thereto. For example, the electronic system 20 can be a personal digital assistant(PDA) or a mobile phone, the logical sectors 25(1)˜25(N) are what the file allocation table(FAT) subsystem divides/defines in the storage space, and the physical sectors 26(1)˜26(N) are what the disc driver divides/defines in a disc storage device such as a flash memory. The present embodiment adds a write file complete function(WriteFileComplete) between the file allocation table subsystem and the disc driver for informing that the data updating is complete. The function is used to inform the disc driver that all of the logical sectors have been updated after the file allocation table subsystem uses the write sector functions(WriteSectors) of the disc driver to one-by-one update data corresponding to all of the logical sectors belonging to the same file. Meanwhile, the disc driver sets the statuses of the new physical sectors mapped to these updated logical sectors to be “VALID”, and deletes the data in the old physical sectors mapped to these updated logical sectors so as to complete the data updating for the file. If power supply is abruptly cut off before the file allocation table subsystem calls the write sector functions(WriteSectors) of the disc driver to one-by-one update data, all of the data(no matter the data is updated or not) in all of the new physical sectors is deleted, while the logical sectors would still correspond/mapp to the old physical sectors having complete old data stored therein This avoids the mixture of new data and old data, and achieves the power-off protection for data update.

The data updating method disclosed in the above embodiments of the invention determines whether any of the physical sectors is at “BEINGVALIDATED” so as to determine the recovery process for recovering data update after abrupt power-off. This avoids the mixture of new and old data, and achieves the power-off protection for data update.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A file updating method applied in an electronic system for updating data, wherein the electronic system comprises:
at least a logical sector; and
at least a physical sector, wherein each logical sector mapps/corresponds to a physical sector in which the data corresponding to the logical sector is stored;
wherein the file is stored in the electronic system and comprises at least a file logical sector, each file logical sector mapps/corresponds to a first physical sector in which the data corresponding to the file logical sector is stored, and the file comprises a to-be-updated data region comprising at least an update logical sector, each of which corresponds to a first physical sector;
wherein the method comprises:
step a: obtaining and mapping an available second physical sector to an update logical sector in the data region;
step b: writing the update data corresponding to the update logical sector into the second physical sector;
step c: repeating the steps a and b until the update data corresponding to all of the update logical sectors in the data region has been written into the mapped/corresponding second physical sectors thereof; and
step d: setting the statuses of all of the second physical sectors mapped to the update logical sectors to be “BEINGVALIDATED”.

2. The method according to claim 1, further comprising:
deleting the data in the first physical sector(s) mapped to the update logical sector(s) in the data region and setting the status(es) of the first physical sector(s) to be “DELETED”.

3. The method according to claim 1, further comprising:
setting the statuses of all of the second physical sectors mapped to the update logical sectors to be “VALID”.

4. A file updating method applied in an electronic system for updating data, wherein the electronic system comprises:
at least a logical sector; and
at least a physical sector, wherein each logical sector mapps/corresponds to a physical sector in which the data corresponding to the logical sector is stored;
wherein the file is stored in the electronic system and comprises at least a file logical sector, wherein each file logical sector mapps/corresponds to a first physical sector in which the data corresponding to the file logical sector is stored, and the file comprises a to-be-updated data region comprising at least an update logical sector, each of which corresponds to a first physical sector;
wherein the method comprises:
step a: obtaining and mapping an available second physical sector to an update logical sector in the data region;
step b: writing the update data corresponding to the update logical sector into the second physical sector;
step c: repeating the steps a and b until the update data corresponding to all of the update logical sectors in the data region has been written into the mapped second physical sectors thereof; and
step d: setting the status of at least one of the second physical sectors mapped to the update logical sectors to be “BEINGVALIDATED.”

5. The method according to claim 4, further comprising:
deleting the data in the first physical sector(s) mapped to the update logical sector(s) in the data region and setting the status(es) of the first physical sector(s) to be “DELETED”.

6. The method according to claim 4, further comprising:
setting the statuses of all of the corresponding second physical sectors mapped to the update logical sectors to be “VALID.”

7. An electronic system, comprising:
at least a logical sector;
at least a physical sector, wherein each logical sector mapps/corresponds to a physical sector in which the data corresponding to the logical sector is stored;
at least a file, wherein each file comprises at least a file logical sector, and each file logical sector mapps/corresponds to a first physical sector in which the data corresponding to the file logical sector is stored, the file comprises a to-be-updated data region comprising at least an update logical sector, each of which corresponds to a first physical sector;
an available physical sector obtain module for obtaining and mapping an available second physical sector to an update logical sector in the data region;
a write module for writing the update data corresponding to the update logical sector into the second physical sector;
a first determine module for determining whether the update data corresponding to all of the update logical sectors in the data region has been written into the mapped second physical sectors thereof; and
a first status-setting module for setting the statuses of all of the second physical sectors mapped to the update logical sectors to be “BEINGVALIDATED”.

8. The system according to claim 7, further comprising:
a delete module for deleting the data in the first physical sector(s) mapped to the update logical sector(s) in the data region and setting the status(es) of the first physical sector(s) to be “DELETED”.

9. The system according to claim 7, further comprising:
a second status-setting module for setting the statuses of all of the second physical sectors mapped to the update logical sectors to be “VALID”.

10. The system according to claim 7, further comprising:
a second determine module for determining whether the status of any of the second physical sectors mapped to the update logical sectors is “BEINGVALIDATED”.

11. An electronic system, comprising:
at least a logical sector;
at least a physical sector, wherein each logical sector mapps/corresponds to a physical sector in which the data corresponding to the logical sector is stored;
at least a file, wherein each file comprises at least a file logical sector, and each file logical sector mapps/corresponds to a first physical sector in which the data corresponding to the file logical sector is stored, the file comprises a to-be-updated data region comprising at least an update logical sector, each of which corresponds to a first physical sector;
an available physical sector obtain module for obtaining and mapping an available second physical sector to an update logical sector in the data region;
a write module for writing the update data corresponding to the update logical sector into the second physical sector;
a first determine module for determining whether the update data corresponding to all of the update logical sectors in the data region has been written into the mapped/corresponding second physical sectors thereof; and
a first status-setting module for setting the status of at least one of the second physical sectors mapped to the update logical sectors to be “BEINGVALIDATED”.

12. The system according to claim 11, further comprising:
a delete module for deleting the data in the first physical sector(s) mapped to the update logical sector(s) in the data region and setting the status(es) of the first physical sector(s) to be “DELETED”.

13. The system according to claim 11, further comprising:
a second status-setting module for setting the statuses of all of the second physical sectors mapped to the update logical sectors to be “VALID”.

14. The system according to claim 11, further comprising:
a second determine module for determining whether the status of any of the second physical sectors mapped to the update logical sectors is “BEINGVALIDATED”.

15. A method for recovering data update applied in an electronic system, wherein the electronic system comprises:
at least a logical sector;
at least a physical sector, wherein each logical sector mapps/corresponds to a physical sector in which the data corresponding to the logical sector is stored;
at least a file, wherein each file comprises at least a file logical sector, and each file logical sector mapps/corresponds to a first physical sector in which the data corresponding to the file logical sector is stored, the file comprises a to-be-updated data region comprising at least an update logical sector, each of which mapps/corresponds to a first physical sector; and
at least a second physical sector mapped/corresponding to an update logical sector in the data region;
wherein the method comprises:
determining whether any of the second physical sectors mapped to the update logical sectors is at “BEINGVALIDATED” status;
performing an update-completing procedure when any of the second physical sectors mapped to the update logical sectors is at “BEINGVALIDATED” status; and
performing an updated-data-deleting procedure when all of the second physical sectors mapped to the update logical sectors are not at “BEINGVALIDATED” status.

16. The method according to claim 15, wherein the update-completing procedure comprises:.
deleting the data in the first physical sector(s) mapped to the update logical sector(s) in the data region and setting the status(es) of the first physical sectors to be “DELETED”.

17. The method according-to claim 16, wherein the update-completing procedure further comprises:
setting the statuses of all of the second physical sectors mapped to the update logical sectors to be “VALID”.

18. The method according to claim 15, wherein the updated-data deleting procedure comprises:
deleting the data in the second physical sector(s) mapped/corresponding to the update logical sector(s).
